(19) United States
(12) Patent Application Publication
(10) Pub. No.: US 2006/0293442 A1
(43) Pub. Date: Dec. 28, 2006

(54) Polyester-urethane (meth) acrylate resins

(76) Inventor: Danny G. Hartinger, Hudson, WI (US)

Correspondence Address: Martin Connaughton;Ashland Licensing and, Intellectual Property LLC, 5200 Blazer Parkway, Dublin, OH, 43017, US

(21) Appl. No.: 11/435,315

(22) Filed: May 16, 2006

Related U.S. Application Data
(60) Provisional application No. 60/681,880, filed on May 17, 2005.

(51) Int. Cl. C08G 18/08

(52) U.S. Cl. 524/589

(57) ABSTRACT

Thermoset resins are disclosed with high strength and modulus properties. The resins are useful in applications requiring both high strength and high modulus, such as the infrastructure market.

### CROSS REFERENCE TO RELATED APPLICATION

This application claims the benefit of the priority date of U.S. provisional application 60/681880, filed May 17, 2005

### BACKGROUND OF THE INVENTION

Thermoset resins with exceptionally high strength and modulus properties are obtained by capping a low molecular weight, hydroxy terminated polyester resin, being substantially free of a,p-ethylenic unsaturation, with an polyisocyanate compound that has been reacted with a hydroxyalkyl (meth) acrylate. The infrastructure market represents an excellent area for growth of composite materials due to their high strength, light weight and corrosion resistance, compared to the current standard materials of construction (i.e. concrete and steel). Structural composites presently used in this industry are often made by the pultrusion process since high glass contents, as high as 75%, are easily obtained. The pultruded composites typically have very high strength properties.

In addition to strength, another critical property for structural components is modulus or stiffness. Such components include pultruded I-beams that can be used to support a bridge deck or a composite utility pole, which must not sway in the wind or bend under the weight of power lines.

Most pultruded composites are made from isophthalic acid containing unsaturated polyester resins, i.e., resins containing α, β-ethylenic unsaturation, which have good strength properties, but do not typically have high modulus. An unsaturated polyester resin based on phthalic anhydride by comparison has higher modulus but much lower strength and elongation. One way to increase the modulus of an unsaturated polyester resin is to maximize the aromatic content in the backbone and use the shortest chains possible between each aromatic ring to make the resin very rigid. Ideally this “rigid rod like” polymer would only have crosslinkable double bonds on the ends of the molecule to maximize its elongation to break and increase its strength to failure. Ethylene glycol (EG), being the shortest chain glycol, and lowest in molecular weight, would make the ideal glycol for a high modulus unsaturated polyester resin. Ideally, one would then combine EG with either isophthalic acid (IPA) or terephthalic acid (TPA) since they are known to give excellent strength properties. The problem with this is that an EG/IPA or especially an EG/TPA polyester resin is very crystalline and incompatible with styrene monomer. The other aromatic diacid commonly used, phthalic anhydride (PAN), is not typically used for structural applications since it gives an unsaturated polyester with much lower strength properties, typically only 75% that of a comparable IPA or TPA containing unsaturated polyester resin. Using mixtures of PAN with either IPA or TPA will help break up crystallinity, but they give strength properties proportional to the amount of PAN in the unsaturated polyester backbone (i.e. the higher the PAN content, the lower the strength). Mixtures of glycols could be used with IPA and/or TPA to help break up crystallinity, but there is loss in modulus properties.

Another inherent problem in developing a “rigid rod like” unsaturated polyester with exceptional strength and modulus properties is maintaining the cross-linkable double bonds on the ends of the molecule. Unsaturated polyester resins transesterify readily at the temperatures used during the condensation reaction and therefore the unsaturation, such as that provided for by maleate/fumarate esters (the cross-link points), are randomly spread throughout the polymer, rather than concentrated at the ends of the molecule. Today, when higher strength, toughness and/or corrosion resistance are needed, vinyl ester (VE) resins are usually employed instead of unsaturated polyester resins. Vinyl ester resins have higher strength and better elongation than unsaturated polyester resins, but suffer from lower modulus properties. Occasionally epoxies or urethanes are used for specific applications, but these thermoset systems are far more expensive and are much more difficult to process. Neither of these materials is known for having high modulus properties.

Attempts to use hybrids of two or more of the above-mentioned chemistries have been tried.

U.S. Pat. No, 3,478,126 teaches a urethane modified epoxy ester (VE) resin. These compositions have high temperature resistance and good solvent resistance, but are more brittle than standard VE resins and do not have as high strength or modulus.

U.S. Pat. No. 3,876,726 teaches a “vinyl ester urethane” which is actually an UPE oligimer made from propoxylated bisphenol A and an unsaturated, aliphatic, dicarboxylic acid or anhydride which is then endcapped with a diisocyanate and a hydroxy-terminated ester of acrylic or methacrylic acid. Although these resins have good strength and corrosion resistance, they do not have exceptional modulus.

Amoco Chemicals Corporation has published information on isophthalic acid containing unsaturated polyester resins that have been urethane modified by reaction with isocyanates. “Hybrid Isophthalic Polyester Urethanes; 37^{th} Annual Conference, Reinforced Plastics/Composites Institute, The Society of the Plastics Industry, Inc. Jan. 11-15, 1982. These resins also exhibit good strength and toughness, but do not have exceptional modulus.

U.S. Pat. No. 5,756,600 teaches urethane-modified epoxy vinyl ester resins. These compositions have good strength and toughness as well as corrosion resistance, but they do not have exceptional modulus. What is needed is a thermosetting resin with both high strength and modulus properties that also has adequate toughness (elongation) to meet the requirements of the infrastructure market.

The present invention meets the requirements of the infrastructure market by providing thermoset polyester resins having a tensile strength greater than 11,000 psi (pounds per square inch), preferably greater than 12,000 psi; flexural strength greater than 18,000 psi, preferably greater than 20,000 psi and both tensile modulus and flexural modulus of greater than 500 ksi (1 ksi =1000 psi).

### SUMMARY OF THE INVENTION

The present invention provides thermoset polyester resins substantially free of α, β-ethylenic unsaturation along the backbone of the resin having both high tensile and flexural strength and high modulus, a method of preparing the polyester resins and structural components prepared therefrom. The polyester resins comprise a hydroxy terminated polyester substantially free of α, β-ethylenic unsaturation along the backbone of the resin, capped with a (meth) acrylate functionalized isocyanate component.

One method of preparing these resins consists of first preparing an aromatic polyester resin containing no α, β-ethylenic unsaturation by conventional means and then reacting the resin with a (meth) acrylate functionalized isocyanate compound. The aromatic polyester resins can be used in any application requiring both high strength and high modulus properties, for articles for the infrastructure market. Non-limiting examples of which include a sheet, rod, pole, structural beam, grating I-beam, box beam, piling, utility pole, windmill blade and the like. Such items are generally produced by a pultrusion or vacuum infusion process.

### DETAILED DESCRIPTION OF THE INVENTION

A thermoset resin with both high strength and modulus has been developed from a hydroxy terminated, polyester resin substantially free of α, β-ethylenic unsaturation along the backbone of the resin, capped with a diisocyanate where one of the isocyanate groups is reacted with a hydroxy-terminated ester of (meth) acrylic acid.

The hydroxy terminated polyester is readily made from the reaction of aromatic and/or alicyclic carboxylic acids free of α, β-ethylenic unsaturation substituents having at least two carboxyl functional groups and polyfunctional alcohols free of α, β-ethylenic unsaturation.

Examples of suitable carboxylic acid monomers include carboxylic acids having at least two carboxyl functional groups or their corresponding anhydrides such as, isophthalic acid (IPA), terephthalic acid (TPA), phthalic acid (PA), phthalic anhydride (PAN), tetrahydrophthalic acid (THPA), tetrahydrophthalic anhydride (THPAN), hexahydrophthalic acid (HHPA), hexahydrophthalic anhydride (HHPAN), cyclohexane dicarboxylic acid (CHDA), 5,norbornene-2, 3-dicarboxylic acid (nadic acid), 5-norbornene-2, 3-dicarboxylic anhydride (nadic anhydride) and the like. Although it is preferred that the polyester resin is prepared from carboxylic acids free of α, β-ethylenic substituents, up to 6.0 wt %, or in another embodiment up to 5.0 wt % of the carboxylic acids, based on the weight of the resin can be carboxylic acids containing α, β-ethylenic unsaturation. Examples include maleic acid, maleic anhydride, fumaric acid, itaconic acid and mixtures thereof.

Examples of suitable alcohols include polyfunctional alcohols having at least two hydroxyl groups such as difunctional alcohols including, ethylene glycol (EG), propylene glycol (PG), 1,3-propanediol (PD), 2-methyl-1, 3 propanediol (MPD), neopentyl glycol (NPG), diethylene glycol (DEG), dipropylene glycol (DPG), 1,3-butylene glycol, 1,4-butylene glycol, 1,6-hexanediol, 2,2-butylethyl propanediol, cyclohexanedimethylol, trimethylpentanediol, hydrogenated bisphenol A, ethoxylated bisphenol A, propoxylated bisphenol A and the like. It is preferred that the alcohols used herein have a molecular weight (Mₙ) of no greater than 1,000.

Reinforcing fillers are present when the thermosetting resins are used to prepare articles in infrastructure applications. In the pultrusion process reinforcing materials are used in amounts of about 50 wt % to about 75 wt % based on the total weight of the resin. The reinforcing filler materials can comprise any combination of rovings, mats, woven fabrics, veils, fibers and/or whiskers, composed of glass, including E-glass and S-glass, as well as carbon, metal, high modulus organic fibers, boron, aluminum silicate, basalt or mixtures thereof. The thermoset resins of the present invention can be used as any other thermoset resins known in the art are used.

The reaction between the carboxylic acid and the alcohol is carried out using an appropriate excess of the alcohol to control the polyester resin chain to the desired length. The use of glycols with two primary alcohols is preferable due to their fast reaction rates with isocyanates. It is also preferable to use the shortest chain and lowest molecular weight glycol to maximize the aromatic/alicyclic content in the hydroxy terminated polyester. The hydroxy terminated polyester can then be thinned in a suitable monomer and stored for later use or it can be reacted immediately with the (meth) acrylate functionalized isocyanate compound.

In one embodiment, the (meth) acrylate functionalized isocyanate compound is made from the reaction of a diisocyanate; e.g., toluene diisocyanate (TDI), methylene diphenyl diisocyanate (MDI), isophorone diisocyanate (IPDI), etc., and a hydroxy alkyl (meth) acrylate; e.g., hydroxyethyl (meth) acrylate, hydroxypropyl (meth) acrylate, polyoxyalky (meth) acrylates, etc. It is preferable to use aromatic diisocyanates to maximize the polymer backbone stiffness and most preferably to use TDI since both isocyanate groups are attached to the same aromatic ring. It is preferable to use hydroxypropyl methacrylate (HPMA) since it is more selective in mono reacting with TDI. Also, the HPMA/TDI urethane is not crystalline and is soluble in styrene monomer. The hydroxyethyl methacrylate (HEMA)/TDI urethane is crystalline and precipitates out of a styrene solution. Hydroxy alkyl methacrylate esters are preferable over their acrylate counterparts due to their better corrosion resistance.

The hydroxy terminated aromatic polyester (HTAP) is made in a standard reactor for making unsaturated polyester resins, using standard temperatures, inert gas sparge rates, etc. The methacrylate-functionalized monoisocyanate (MFMI) can be made simultaneously in the thin tank used in the production of unsaturated polyester resins. Typical conditions are 1 hour at 180° F. for the reaction of HPMA with TDI using parabenzoquinone as the free radical inhibitor. Dibutyl tin dilaurate or other catalysts may be used to speed up the reaction. When both steps are completed, the molten HTAP is then dropped into the thin tank containing styrene and the MFMI and are allowed to react; typically 4 hours at 180° F. Dibutyl tin dilaurate or other catalysts may be used to speed up the reaction of the isocyanate and the hydroxyl groups on the hydroxy terminated aromatic polyester. The HTAP should be used in amounts so as to provide an excess of alcohol (typically 2-10%) to isocyanate. The reaction is finished when essentially no NCO groups remain, as measured by IR spectroscopy. After this reaction is complete, additional styrene (or other vinyl monomers) may be added to obtain the desired viscosity and the reactants are cooled to room temperature.

In another embodiment a diisocyanate is reacted with the hydroxy terminated aromatic polyester. The isocyanate-capped polyester is then reacted with a hydroxy alkyl (meth) acrylate.

In this embodiment it is preferable to use a secondary alcohol as the glycol to mono-react the TDI onto the polyester. You would then use hydroxyethyl methacrylate instead of hydroxypropyl methacrylate since the second isocyanate group of TDI is far less reactive than the first. Endcapping with hydroxypropyl methacrylate is less desirable because it would require higher reaction temperatures and thus more inhibitor and more inhibitor leads to longer gel times, which is undesirable for resins ultimately used in pultrusion process.

The preparation of the hydroxy terminated polyesters (HTAP) in the following examples were carried out in a 2 or 3 liter glass resin flask, equipped with an agitator and sparge tube (nitrogen was used as the inert gas). A thermocouple attached to a Thermowatch® temperature controller was used to control the reaction temperature in combination with an electric heating mantle. A partial condenser was used initially to control glycol losses and was removed once the reactants reached top temperature (420-440° F.) and the column temperature dropped below 170° F. A water-cooled condenser was used to collect the distillate.

The preparation of the methacrylate functionalized monoisocyanate (MFMI) in the following examples were carried out in a 2 liter resin flask, equipped as above except that 1) dry air was used to sparge the reactants, and 2) a water cooled, total condenser was used to keep any volatiles within the resin flask.

### COMPARATIVE EXAMPLE #1

Using the polyesterification equipment listed above, 1,330 gms of propylene glycol (17.50 moles) was charged into a 3-liter flask and heated to 200° F. Then 779.4 gms of maleic anhydride (7.95 moles) and 1,177.2 gms of phthalic anhydride (7.95 moles) were charged into the reactor, along with 3.0 gms of dibutyl tin oxide esterification catalyst. The contents where heated to 420° F., esterified to an acid value (AV)=12.8, (based on ASTM method D 1639-90) and then cooled to 350° F. before being thinned in 1,615.5 gms of styrene monomer and 0.3 gms of hydroquinone (HQ). This unsaturated polyester resin had a viscosity of 1,504 cps (based on ASTM methods D2393-86 and D1824-90) at 63.3% nonvolatiles (NV) (based on ASTM method D1644-88). A casting made from this resin had the physical properties listed in Table #1 below. Also shown in the table below are the physical properties of AROPOL ®7241, an isophthalic acid version of C.E. #1 commercially available from Ashland Inc.; HETRON® 922, a vinyl ester resin commercially available from Ashland Inc.; ATLAC 580-05, a “vinyl ester urethane” commercially available from Reichold Chemicals; and a 2 component, high performance epoxy resin system (EPON 826/MPDA in a 100/15 ratio) commercially available from Resolution Performance Products.

### EXAMPLE #1

202.7 gms of propylene glycol (2.67 moles) and 277.3 gms of neopentyl glycol (2.67 moles) were added to a 2-liter flask and heated to 300° F. Next 644.0 gms of isophthalic acid (4.00 moles) was added and the reactants were esterified at 440° F. until an AV=5.9 was obtained to form a hydroxy terminated aromatic polyester resin. The molten plastic polyester resin was thinned into 1,168.0 gms of styrene and 0.2 gms of MTBHQ and cooled to room temperature. The resin was then transferred to a 3-liter flask and 464.0 gms of toluene diisocyanate (2.67 moles) and 0.5 gms of DBTDL catalyst were added to the polyester resin. Then 364.0 gms of hydroxyethyl methacrylate (2.80 moles) and 3.7 gms of DBTDL were added to react with the remaining isocyanate groups and cap the polyester/urethane resin. This polyester/urethane hybrid resin had a viscosity of 450 cps at 61.1% NV, and was slightly crystalline. The casting physical properties are listed in Table #2.

### EXAMPLE #2

520.9 gms of diethylene glycol (4.91 moles) was added to a 2-liter flask and heated to 300° F. Then 611.8 gms of isophthalic acid (3.69 moles) were added and the reactants were esterified at 440° F. until an AV less than 10 was obtained to form a hydroxy terminated aromatic polyester resin. The molten plastic resin was then thinned in 1,168.0 gms of styrene and 0.2 gms MTBHQ and cooled to room temperature. This resin was then transferred to a 3-liter flask and 427.5 gms of toluene diisocyanate (2.46 moles) and 0.5 gms of DBTDL were added. Then 335.4 gms of hydroxyethyl methacrylate (2.58 moles) and 3.5 gms of DBTDL were added to cap the polyester/urethane resin. The final product was very crystalline and a viscosity could not be obtained. However the resin was heated up to 160° F., catalyzed, and made into a casting in order to check physical properties. The results are listed in Table #2.

### EXAMPLE #3

209.0 gms of propylene glycol (2.75 moles) and 286.0 gms of neopentyl glycol (2.75 moles) were added to a 2-liter flask and heated to 300° F. Then 684.8 gms of isophthalic acid (4.12 moles) were added and the reactants were esterified at 420° F. until an AV=5.5 was obtained to form a hydroxy terminated aromatic polyester resin. The molten plastic resin was then thinned in 1,050.0 gms of styrene and 0.2 gms HQ and cooled to room temperature. This resin was then transferred to a 3-liter flask and 478.5 gms of toluene diisocyanate (2.75 moles) and 4.0 gms of DBTDL were added to the HTAP. Then 436.0 gms of hydroxypropyl methacrylate (3.02 moles) were added to cap the polyester/urethane resin. This resin had a viscosity of 1,560 cps at 64.6% NV, and was not crystalline. The casting physical properties are listed in Table #2.

### EXAMPLE #4

556.8 gms of diethylene glycol (5.25 moles) and 653.9 gms of isophthalic acid (3.94 moles) were added to a 2 liter flask and esterified at 440° F. until an AV less than 10 was obtained to form a hydroxy terminated aromatic polyester resin. The molten plastic polyester resin was then thinned in 1,050.0 gms of styrene and 0.2 gms HQ and cooled to room temperature. This resin was then transferred to a 3-liter flask and 456.9 gms of TDI (2.63 moles) and 4.0 gms of DBTDL. Then 416.0 gms of hydroxypropyl methacrylate (2.89 moles) were added to cap the polyester/urethane resin. This resin had a viscosity of 870 cps at 63.7% NV, and was not crystalline. The casting physical properties are listed in Table #2.

### EXAMPLE #5

330.4 gms of neopentyl glycol (3.18 moles) and 141.9 gms of TMP (1.06 moles) were added to a 2 liter flask and heated to 300° F. Then 527.5 gms of isophthalic acid (3.18 moles) were added and the reactants esterified at 420° F. until an AV =9.4 was obtained to form a hydroxy terminated aromatic polyester. The molten polyester resin was then thinned in 1,050.0 gms of styrene and 0.6 gms HQ and cooled to room temperature. This resin was then transferred to a 3-liter flask and 552.6 gms of TDI (3.18 moles) and 4.0 gms of DBTDL were added. Then 503.3 gms of hydroxypropyl methacrylate (3.50 moles) were added to cap the resin. An additional 500 gms of styrene was added to the hybrid resin to obtain a viscosity of 2,540 cps. The casting physical properties are listed in Table #3.

### EXAMPLE #6

1,166.1 gms of EG (18.81 moles) and 2,087.7 gms of phthalic anhydride (14.11 moles) were added to a 3 liter flask and esterified at 440° F. until an AV=5.0 was obtained, to form a hydroxy terminated aromatic polyester. The molten polyester resin was then thinned in 1,285.8 gms of styrene and 0.3 gms HQ and cooled to room temperature. In another 3 liter flask, 526.0 gms of toluene diisocyanate (3.02 moles), 478.9 gms of hydroxypropyl methacrylate (3.32 moles), 0.2 gms PBQ and 0.2 gms of DBTDL were reacted together for 1 hour at 180° F. Then 1,651.4 gms of the styrenated solution was added to the flask and reacted for 4 hours at 180° F. An additional 437.0 gms of styrene was added to give a polyester/urethane hybrid resin with a viscosity of 2,900 cps at 69.0% NV. The casting physical properties are listed in Table #3.

### EXAMPLE #7

1,548.3 gms of neopentyl glycol (14.89 moles) and 1,652.7 gms of phthalic anhydride (11.17 moles) were added to a 3 liter flask and esterified at 440° F. until an AV=8.8 was obtained to form a hydroxy terminated aromatic polyester resin. The molten polyester resin was then thinned in 1,285.8 gms of styrene and 0.3 gms HQ and cooled to room temperature. In another 3 liter flask, 441.0 gms of toluene diisocyanate (2.53 moles), 401.4 gms of hydroxypropyl methacrylate (2.79 moles), 0.2 gms PBQ and 0.2 gms of DBTDL were reacted together for 1 hour at 180° F. Then 1,786.6 gms of the styrenated solution was added to the flask and reacted for 4 hours at 180° F. An additional 364.3 gms of styrene was added to give a polyester/urethane hybrid resin with a viscosity of 1,760 cps at 67.8% NV. The casting physical properties are listed in Table #3.

### EXAMPLE #8

1,251.0 gms of neopentyl glycol (20.18 moles) and 1,991.1 gms of phthalic anhydride (13.45 moles) were added to a 3 liter flask and esterified at 440° F. until an AV=3.5 was obtained to form a hydroxy terminated aromatic polyester resin. The molten polyester resin was then thinned in 1,285.8 gms of styrene and 0.15 gms HQ and cooled to room temperature. In another 3 liter flask, 660.0 gms of toluene diisocyanate (3.79 moles), 600.0 gms of hydroxypropyl methacrylate (4.17 moles), 0.2 gms PBQ and 0.2 gms of DBTDL were reacted together for 1 hour at 180° F. Then 1,438.0 gms of the styrenated solution was added to the flask and reacted for 4 hours at 180° F. An additional 743.8 gms of styrene was added to give a polyether/urethane hybrid resin with a viscosity of 1,082 cps at 65.6% NV. The casting physical properties are listed in Table #3.

Castings from the above examples were all prepared as follows. The castings were made by first catalyzing 400 grams of resin with 4 grams of benzoyl peroxide (dissolved in 4 grams of styrene) and 4 grams of tert-butyl benzoate. The catalyzed resin was poured between 2 glass plates with an ⅛-in. gasket separating the plates. The plates were clamped and placed in an oven. The plates were heated for 4 hours at 150° F. and then 2 hours at 200° F. The cured resin casting was then cooled, demolded and cut into coupons for testing. The coupons were post-cured for 2 hours at 280° F. before testing.

TABLE #1

| | | AROPOL ® | HETRON ® | ATLAC | EPON 826 |
|---|---|---|---|---|---|
| | C.E. #1 | 7241 | 922 | 580-05 | MPDA |
| Tensile Strength, psi | 8,930 | 10,700 | 12,650 | 12,040 | 13,300 |
| Tensile Modulus, ksi | 593 | 540 | 457 | 508 | 440 |
| Tens. Elongation, % | 1.7 | 2.4 | 6.7 | 4.2 | 6.1 |
| Flex. Strength, psi | 15,790 | 19,000 | 20,660 | 22,190 | NA |
| Flex. Modulus, ksi | 610 | 590 | 503 | 515 | NA |
| Heat Distortion, ° F. | 206 | 210 | 221 | 239 | 314 |

TABLE #2

| | Example #1 | Example #2 | Example #3 | Example #4 |
|---|---|---|---|---|
| Tensile Strength, psi | 15,010 | 14,820 | 14,060 | 14,850 |
| Tensile Modulus, ksi | 618 | 580 | 605 | 631 |
| Tensile Elongation, % | 3.2 | 3.7 | 2.7 | 3.1 |
| Flex. Strength, psi | 19,170 | 23,740 | 21,560 | 22,560 |
| Flex. Modulus, ksi | 589 | 567 | 583 | 583 |
| Compressive Strength, psi | 21,290 | 20,590 | 22,000 | 21,700 |
| Comp. Modulus, ksi. | 650 | 595 | 659 | 605 |
| Heat Distortion, ° F. | 205 | 158 | 210 | 163 |

TABLE #3

| | Example #5 | Example #6 | Example #7 | Example #8 |
|---|---|---|---|---|
| Tensile Strength, psi | 13,260 | 15,260 | 13,320 | 15,160 |
| Tensile Modulus, ksi | 536 | 679 | 625 | 696 |
| Tensile Elongation, % | 3.2 | 2.9 | 2.7 | 2.8 |
| Flex. Strength, psi | 20,680 | 18,600 | 17,410 | 24,450 |
| Flex. Modulus, ksi | 535 | 647 | 627 | 686 |
| Compressive Strength, psi | 20,000 | 24,390 | 22,120 | 26,160 |
| Comp. Modulus, ksi. | 547 | 674 | 627 | 667 |
| Heat Distortion, ° F. | 226 | 181 | 182 | 200 |

Having thus described the invention, I claim:

1. A thermosetting resin, comprising the reaction product of;
A. a hydroxyl terminated polyester resin, comprising the reaction product of;
i. an aromatic or alicyclic carboxylic acid monomer or its corresponding anhydride having at least two carboxyl functional groups, wherein up to 6.0 wt % of the monomer based on the total weight of the polyester resin is a carboxylic acid monomer or its corresponding anhydride containing α,β-ethylenic unsaturation, and
ii. a polyfunctional alcohol free of α,β-ethylenic unsaturation, with
B. a hydroxyalkyl (meth)acrylate modified polyisocyanate having at least free isocyanate group,
wherein the cured resin has a tensile strength of at least 11,000 psi and a flexural strength of at least 18,000 psi.

2. The thermosetting resin of claim 1, wherein up to 5 wt % of the carboxylic acid monomer contains α,β-ethylenic unsaturation.

3. The thermosetting resin of claim 1, wherein the hydroxyl terminated polyester resin is free of α,β-ethylenic unsaturation.

4. The thermosetting resin of claim 1, wherein the cured resin has a tensile strength of at least 12,000 psi.

5. The thermosetting resin of claim 1, wherein the cured resin has a flexural strength of at least 20,000 psi.

6. The thermosetting resin of claim 1, wherein the cured resin has a tensile modulus and flexural modulus of at least 500 ksi.

7. The thermosetting resin of claim 1, wherein the carboxylic acid monomer or its corresponding anhydride comprises at least one isophthalic acid, terephthalic acid, phthalic acid, phthalic anhydride, tetrahydrophthalic acid, tetrahydrophthalic anhydride, hexahydrophthalic acid, hexahydrophthalic anhydride, cyclohexane dicarboxylic acid, 5,norbornene-2, 3-dicarboxylic acid, or 5-norbornene-2, 3-dicarboxylic anhydride.

8. The thermosetting resin of claim 1, wherein the polyfunctional alcohol comprises at least one ethylene glycol, propylene glycol, 1,3-propanediol, 2-methyl-1,3 propanediol, neopentyl glycol, diethylene glycol, dipropylene glycol, 1,3-butylene glycol, 1,4-butylene glycol, 1,6-hexanediol, 2,2-butylethyl propanediol, cyclohexanedimethylol, trimethylpentanediol, hydrogenated bisphenol A, ethoxylated bisphenol A, or propoxylated bisphenol A.

9. The thermosetting resin of claim 1, wherein the hydroxyalkyl (meth)acrylate modified polyisocyanate is a hydroxypropyl methacrylate modified toluene diisocyanate.

10. The thermosetting resin of claim 1, further comprising a reinforcing filler.

11. The thermosetting resin of claim 10, wherein the reinforcing filler type is a roving, mat, veil, fiber and/or whisker.

12. An article suitable for use in the infrastructure market, comprising; the thermosetting resin of claim 1.

13. The article of claim 12, where said article is a sheet, rod, pole, structural beam, grating I-beam, box beam, piling, utility pole or windmill blade.
